(19) United States
(12) Patent Application Publication
(10) Pub. No.: US 2017/0131479 A1
(43) Pub. Date: May 11, 2017

(54) OPTICALLY VISUALIZED ANTI-COUNTERFEITING ELECTRONIC INTEGRATED APPARATUS AND MANUFACTURING METHOD THEREOF

(71) Applicant: NATIONAL CHIAO TUNG UNIVERSITY, Hsinchu City (TW)

(72) Inventors: Wen-Chieh LIN, Taichung City (TW); Mu-Tien LU, New Taipei City (TW)

(21) Appl. No.: 15/014,031

(22) Filed: Feb. 3, 2016

(30) Foreign Application Priority Data
Nov. 10, 2015 (TW) 104137045

(51) Int. Cl. G02B 6/34; G02B 6/24; F21V 5/02

(52) U.S. Cl. CPC G02B 6/34; F21V 5/02; G02B 6/243; F21Y 2113/13

(57) ABSTRACT

An optically visualized anti-counterfeiting electronic integrated apparatus includes a housing, light sources and spectroscopic structures. The housing has tunnels each with an incident end and an exit end respectively present on opposite sides of the housing. The light sources are respectively configured to emit first lights with a first spectrum range. The spectroscopic structures are respectively disposed in the channels, and are respectively configured to separate second lights from the first lights to the exit ends, in which the second lights have a second spectrum range within the first spectrum range.

### RELATED APPLICATIONS

This application claims priority to Taiwanese Application Serial No. 104137045, filed Nov. 10, 2015, which is herein incorporated by reference.

### BACKGROUND

Technical Field

The present disclosure relates to an optically visualized anti-counterfeiting electronic integrated apparatus and a manufacturing method thereof.

Description of Related Art

With conventional rigid-body goods, the anti-counterfeit trademark design is an indispensable part. The purpose in the evolution of technology from using security stickers to using housing embossing, and then eventually to manufacturing and designing involving integral formation is to achieve the effect of anti-counterfeiting by using different processes or different materials, so as to curb counterfeiting by unscrupulous businessmen.

So far, most of these anti-counterfeiting technologies have been limited only to the design of the external housing of goods while the internal structures of the goods have not yet been properly used and designed. Hence, this area still leaves much room for development.

In other words, these technologies offer poor protection when encountering vandalism (e.g., tearing of stickers), or with respect to reverse engineering (e.g., three-dimensional reconstruction of housing). Regarding some anti-counterfeit mark recognition technologies related to invisible recognition words, particular conditions must be present for such technologies to be realized (e.g., radiating the invisible recognition words with ultraviolet light). That is, such technologies do not allow consumers to use their vision in a normal environment, and therefore are not suitable as anti-counterfeit trademark applications.

### SUMMARY

Accordingly, an aspect of the disclosure is to provide an optically visualized anti-counterfeiting electronic integrated apparatus to solve the above-mentioned problems.

The disclosure provides an optically visualized anti-counterfeiting electronic integrated apparatus includes a housing, a plurality of light sources, and a plurality of spectroscopic structures. The housing has a plurality of tunnels. Each of the tunnels has an incident end and an exit end respectively present on opposite sides of the housing. The light sources are configured to respectively emit first lights toward the incident ends. The first lights have a first spectrum range. The spectroscopic structures are respectively disposed in the tunnels and respectively configured to separate second lights from the first lights to the exit ends. The second lights have a second spectrum range within the first spectrum range.

In an embodiment of the disclosure, each of the tunnels has a first path, a second path, and a third path sequentially connected and substantially extended along different directions. The incident end is located at an end of the first path away from the second path. The exit end is located at an end of the third path away from the second path. Each of the spectroscopic structures is located in the corresponding second path.

In an embodiment of the disclosure, each of the spectroscopic structures has an incident surface and an exit surface respectively adjacent to the corresponding first path and the corresponding third path. The incident surface is configured to refract the first light into the spectroscopic structure. The exit surface is configured to refract the first light in the spectroscopic structure to obtain the second light separated from the first light, and the second light leaves the exit surface and then enters the corresponding third path.

In an embodiment of the disclosure, the optically visualized anti-counterfeiting electronic integrated apparatus further includes a plurality of fiber optic assemblies respectively disposed in the tunnels. Two ends of each of the fiber optic assemblies are respectively located at the corresponding incident end and the corresponding exit end. Each of the spectroscopic structures is disposed in the corresponding fiber optic assembly.

In an embodiment of the disclosure, each of the fiber optic assemblies includes two optical fibers and a cladding member. The optical fibers are respectively located between the corresponding incident end and the corresponding spectroscopic structure and between the corresponding spectroscopic structure and the corresponding exit end. The cladding member envelops the optical fibers and the corresponding spectroscopic structure.

In an embodiment of the disclosure, each of the fiber optic assemblies further includes a light-absorbing member. The light-absorbing member is disposed at the inner wall of the cladding member and located between the corresponding spectroscopic structure and the optical fiber adjacent to the exit surface.

In an embodiment of the disclosure, the ends of each of the fiber optic assemblies are respectively filled and trimmed flush with the corresponding incident end and the corresponding exit end.

In an embodiment of the disclosure, each of the spectroscopic structures is at least a part of a prism, and the part is configured to refract the first light twice.

The disclosure further provides a manufacturing method of an optically visualized anti-counterfeiting electronic integrated apparatus. The manufacturing method includes providing a housing having a plurality of tunnels, wherein each of the tunnels has an incident end and an exit end respectively present on opposite sides of the housing; providing a plurality of light sources, wherein the light sources are configured to respectively emit first lights toward the incident ends, and the first lights have a first spectrum range; and disposing a plurality of spectroscopic structures in the tunnels respectively wherein each of the spectroscopic structures is configured to separate a second light from the first light to the corresponding exit end, and the second light has a second spectrum range within the first spectrum range.

In an embodiment of the disclosure, the providing of the housing includes forming a first path, a second path, and a third path sequentially connected and substantially extended along different directions in the housing to form each of the tunnels, wherein each of the incident ends is located at an end of the corresponding first path away from the corresponding second path, each of the exit ends is located at an end of the corresponding third path away from the corresponding second path, and each of the spectroscopic structures is located in the corresponding second path.

In an embodiment of the disclosure, the disposing of the spectroscopic structures includes disposing a plurality of fiber optic assemblies in the tunnels respectively, wherein two ends of each of the fiber optic assemblies are respectively located at the corresponding incident end and the corresponding exit end, and each of the spectroscopic structures is disposed in the corresponding fiber optic assembly.

In an embodiment of the disclosure, the providing of the housing and the disposing of the fiber optic assemblies are performed by using the additive manufacturing technology.

Accordingly, the optically visualized anti-counterfeiting electronic integrated apparatus of the disclosure is manufactured by using the additive manufacturing technology. By modifying the internal structures in the optically visualized anti-counterfeiting electronic integrated apparatus, vandalism or copying by reverse engineering is prevented. Moreover, the optically visualized anti-counterfeiting electronic integrated apparatus of the disclosure can be mass-produced.

Furthermore, conventional anti-counterfeit mark recognition technologies must be achieved under particular conditions (e.g., radiating invisible recognition words with ultraviolet light). The optically visualized anti-counterfeiting electronic integrated apparatus of the disclosure complies with optics-based designs, which allows users to use their vision in a natural environment. Moreover, the optically visualized anti-counterfeiting electronic integrated apparatus of the disclosure can provide significantly more flexibility to designers by allowing a combination of light and color appearance, so as to allow easier identification.

It is to be understood t hat both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a perspective view of an optically visualized anti-counterfeiting electronic integrated apparatus and a display area thereof according to an embodiment of the disclosure;

FIG. 2 is a cross-sectional view of an optically visualized anti-counterfeiting electronic integrated apparatus according to an embodiment of the disclosure;

FIG. 3 is a cross-sectional view of an optically visualized anti-counterfeiting electronic integrated apparatus according to another embodiment of the disclosure;

FIG. 4 is a schematic diagram of a prism according to an embodiment of the disclosure;

FIG. 5 is a front view of a display area of an optically visualized anti-counterfeiting electronic integrated apparatus according to an embodiment of the disclosure; and

FIG. 6 is a flow chart of a manufacturing method of an optically visualized anti-counterfeiting electronic integrated apparatus according to an embodiment of the disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

The optically visualized anti-counterfeiting electronic integrated apparatus of the disclosure is manufactured by using the additive manufacturing technology. By modifying the internal structures in the optically visualized anti-counterfeiting electronic integrated apparatus, vandalism or copying by reverse engineering is prevented. Moreover, the optically visualized anti-counterfeiting electronic integrated apparatus can be mass-produced. The optically visualized anti-counterfeiting electronic integrated apparatus of the disclosure complies with optics-based designs, which allows users to utilize their vision in a natural environment. Moreover, the optically visualized anti-counterfeiting electronic integrated apparatus of the disclosure can provide significantly more flexibility to designers by allowing a combination of light and color appearance, so as to allow easier identification.

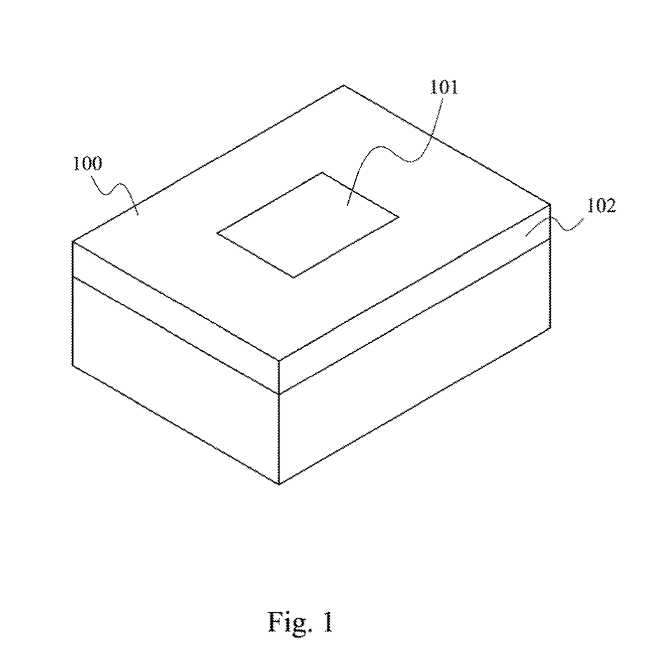

Reference is made to FIG. 1. FIG. 1 is a perspective view of an optically visualized anti-counterfeiting electronic integrated apparatus 100 and a display area 101 thereof according to an embodiment of the disclosure. As shown in FIG. 1, the optically visualized anti-counterfeiting electronic integrated apparatus 100 includes a housing 102, and the display area 101 is formed on an exterior of the housing 102.

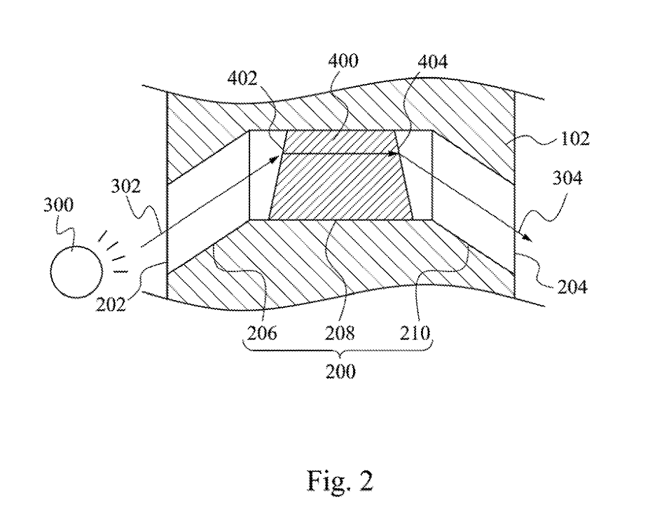

Reference is made to FIG. 2. FIG. 2 is a cross-sectional view of an optically visualized anti-counterfeiting electronic integrated apparatus 100 according to an embodiment of the disclosure. As shown in FIG. 2, in some embodiments, the optically visualized anti-counterfeiting electronic integrated apparatus 100 includes a plurality of light sources 300 (FIG. 2 only shows a single light source 300 as a representative example). The light sources 300 are disposed in the optically visualized anti-counterfeiting electronic integrated apparatus 100 (FIG. 2 only shows a part of the housing 102 for simplicity). The housing 102 has a plurality of tunnels 200 (FIG. 2 only shows a single tunnel 200 as a representative example). Each of the tunnels 200 has an incident end 202 and an exit end 204, in which the incident end 202 and the exit end 204 are respectively present on opposite sides of t he housing 102, and the incident end 202 is the end adjacent to the light sources 300. The light sources 300 are configured to respectively emit first lights 302 toward the incident ends 202. The first lights 302 have a first spectrum range.

As shown in FIG. 2, in addition to the housing 102 and the light sources 300, the optically visualized anti-counterfeiting electronic integrated apparatus 100 further includes a plurality of spectroscopic structures 400 (FIG. 2 only shows a single spectroscopic structure 400 as a representative example). The spectroscopic structures 400 are respectively disposed in the tunnels 200, and are respectively configured to separate second lights 304 from the first lights 302 and direct the second lights 304 to the exit ends 204. The second lights 304 have a second spectrum range.

As shown in FIG. 2, in some embodiments, each of the tunnels 200 has a first path 206, a second path 208, and a third path 210 that are sequentially connected and substantially extended along different directions. The incident end 202 of the tunnel 200 is located at an end of the first path 206 away from the second path 208. The exit end 204 of the tunnel 200 is located at an end of the third path 210 away from the second path 208. Each of the spectroscopic structures 400 is located in the corresponding second path 208.

As shown in FIG. 2, in some embodiments, each of the spectroscopic structures 400 has an incident surface 402 and an exit surface 404. The incident surface 402 and the exit surface 404 are respectively adjacent to the corresponding first path 206 and the corresponding third path 210. The incident surface 402 is configured to refract the first light 302 into the spectroscopic structure 400. The exit surface 404 is configured to refract the first light 302 in the spectroscopic structure 400 to obtain the second light 304 separated from the first light 302, and the second light 304 leaves the exit surface 404 and then enters the third path 210.

The light sources 300 can be any kind of light-emitting sources. For example, the light sources 300 can be CCFLs (cold cathode fluorescent lights), LEDs (light emitting diodes), filament lamps, halogen lamps or the like. Moreover, the light sources 300 can be realized through any formation or style of light-emitting sources. For example, each of the light sources 300 can be a single LED of a single light color or two or more LEDs of different light colors that are mixed. The first spectrum range of the first lights 302 emitted by the light sources 300 is a continuous spectrum range. That is, the first spectrum range is a continuous electromagnetic wave spectrum. In some embodiments, the first spectrum range is the visible light spectrum range from about 380 nm to about 780 nm, but the disclosure is not limited in this regard.

Reference is made to FIG. 4. FIG. 4 is a schematic diagram of a prism 800 according to an embodiment of the disclosure. As shown in FIG. 4 in some embodiments, the spectroscopic structure 400 can be the whole prism 800 or a part of the prism 800 configured to refract the first light 302 twice, but the disclosure is not limited in this regard. The prism 800 is one of the most common spectroscopic structures. Lights of different wavelengths have different indexes of refraction, and the prism 800 can refract and thus separate the lights to be directed at different angles. After being refracted twice, lights with different wavelengths will be separated from the incident light. As discussed above, in some embodiment, first spectrum range of the first lights 302 is a continuous spectrum range. The first spectrum range of the first lights 302 at least includes the visible light spectrum range, for example, at least includes primary colors such as blue, green, and red. The primary colors are respectively in a range from about 476 nm to about 495 nm, in a range from about 495 nm to about 570 nm, and in a range from about 620 nm to about 750 nm. The primary colors have different indexes of refraction, so when the first light 302 enters the spectroscopic structure 400 from the incident surface 402, the first light 302 will then be refracted by the spectroscopic structure 400 twice before leaving the exit surface 404, and the primary colors in the first light 302 will be separated because they deflect at different angles (the blue light has the largest deflection angle, the red light has the smallest deflection angle, and the deflection angle of the green light is between those of the blue light and the red light).

The second light 304 is separated from the spectroscopic structure 400 and has a second spectrum range. The second spectrum range is also a continuous spectrum range, which is a portion of the visible light spectrum range. In some embodiments, the second spectrum range of the second light 304 can be a blue color, a green color, a red color, or other colors of visible spectrum ranges. It should be pointed out that the spectrum range of the second light 304 entering the third path 210 can be adjusted by modifying the extending direction of the third path 210 relative to the second path 208. For example, the closer an angle between the extending direction of the third path 210 and that of the second path 208 is to 90 degrees, the more the spectrum range of the second light 304 entering the third path 210 approaches short wavelengths (i.e., approaches a blue color). On the other hand, the closer an angle between the extending direction of the third path 210 and that of the second path 208 is to 180 degrees, the more the spectrum range of the second light 304 entering the third path 210 approaches long wavelengths (i.e., approaches a red color).

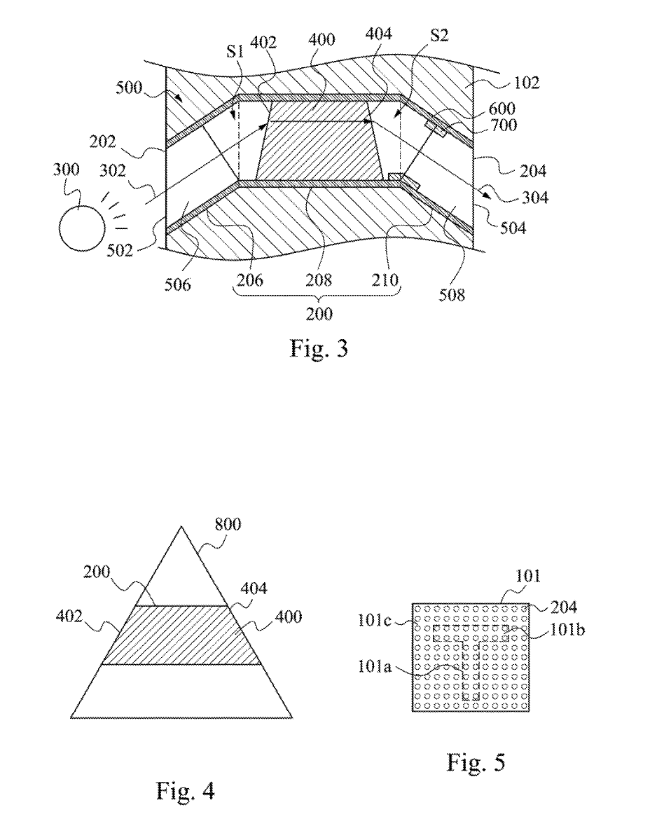

Reference is made to FIG. 3. FIG. 3 is a cross-sectional view of an optically visualized anti-counterfeiting electronic integrated apparatus 100 according to another embodiment of the disclosure. As shown in FIG. 3, in this embodiment, the optically visualized anti-counterfeiting electronic integrated apparatus 100 also includes the housing 102, the light sources 300, and the spectroscopic structures 400. The structures and functions of the housing 102, the light sources 300, and the spectroscopic structures 400, and the physical connection relationships thereamong can be ascertained by reference to the embodiment of FIG. 2 and the related descriptions above, and therefore are not repeated here for the sake of brevity. It should be pointed out that the optically visualized anti-counterfeiting electronic integrated, apparatus 100 can further include a plurality of fiber optic assemblies 500 (FIG. 3 only shows a single fiber optic assembly 500 as a representative example) respectively disposed in the tunnels 200 of the housing 102. Two ends 502 and 504 of each of the fiber optic assemblies 500 are respectively located at the corresponding incident end 202 and the corresponding exit end 204. Each of the spectroscopic structures 400 is disposed in the corresponding fiber optic assembly 500.

In this embodiment, each of the fiber optic assemblies 500 includes two optical fibers 506 and 508 and a cladding member 600. The optical fiber 506 of the fiber optic assembly 500 is located between the incident end 202 and spectroscopic structure 400, and the optical fiber 508 is located between the spectroscopic structure 400 and the exit end 204. The cladding member 600 of the fiber optic assembly 500 is configured to envelop the optical fibers 506 and 508 and the spectroscopic structure 400.

As discussed above, after the first light 302 emitted from the light source 300 is refracted by the spectroscopic structure 400, lights having different spectrum ranges can be separated from the first light 302. In order to refract the light twice by using the spectroscopic structure 400 to obtain the desired spectrum range (i.e., the desired color) and mark at the exit end 204, optical paths must be properly configured to comply with certain optical conditions. In other words, without properly configuring the optical paths to comply with certain optical conditions, the emitted light will scatter and occur loss in the medium (e.g., the housing 102 or the tunnel 200), and the desired spectrum range and mark cannot be obtained at the exit end 204.

The use of the fiber optic assemblies 500 can meet the requirements of design. It should be understood that when light is emitted from an optically denser medium to an optically thinner medium, the refraction angle will be greater than the incidence angle. When the incidence angle is increased to the critical angle θc, the incidence angle can be equal to 90 degrees. if the incidence angle is greater than the critical angle θc, the light will be totally reflected back to the original medium (i.e., the optically denser medium), and this is referred to as TIR (total internal reflection). For example, the indexes of the optically denser medium and the optically thinner medium are respectively n₁ and n₂ (n₁>n₂), and according to Snell's Law (n₁ sinθ₁=n₂ sinθ₂), the critical angle θc satisfies the formula sinθc=n₂/n₁. It is this effect that is used by the fiber optic assemblies 500 to transmit light therein. The angle of the light emitted into the fiber optic assembly 500 must be greater than the critical angle θc to satisfy TIR, so that to allow the first light 302 to be transmitted in the fiber optic assembly 500, the designer must make the angle of the first light 302 emitted by the light source 300 entering the incident end 202 satisfy TIR.

In general, the fiber optic assembly 500 needs at least a cladding layer to protect the fiber optic assembly 500. In some embodiments, the cladding member 600 envelops the optical fibers 506 and 508 and the spectroscopic structure 400.

The structures and functions of the spectroscopic structure 400 and the fiber optic assembly 500 and the physical connection relationships thereamong can be ascertained by reference to the embodiment of FIG. 3 and the related descriptions above, and therefore are not repeated here for the sake of brevity. The procedures related to light being transmitted in the fiber optic assembly 500 and refracted by the spectroscopic structure 400 are described in greater detail below. The light source 300 emits the first light 302 to enter the optical fiber 506 from the end 502 away from the spectroscopic structure 400 with an angle satisfying TIR, and the first light 302 then enters a first space S1 from the end of the optical fiber 506 adjacent to the spectroscopic structure 400. Subsequently, the first light 302 enters the spectroscopic structure 400 through the incident surface 402 and is refracted twice by the spectroscopic structure 400, and the second light 304 then leaves the spectroscopic structure 400 from the exit surface 404 to enter a second space S2. Afterwards, the second light 304 enters the optical fiber 508 from the end adjacent to the spectroscopic structure 400 with an angle satisfying TIR. Finally, the second light 304 leaves the optical fiber 508 from the end 504 away from the spectroscopic structure 400.

As discussed above, lights having different spectrum ranges can be separated from the light refracted by the spectroscopic structure 400, but the designer only desires to obtain the second light 304 having a specific spectrum range after leaving the exit surface 404 of the spectroscopic structure 400. To satisfy such a design requirement, the normal direction of the incident surface of the end of the optical fiber 508 adjacent to the spectroscopic structure 400 must be the same as the traveling direction of the light of the desired spectrum range. In order to precisely obtain the light of the desired spectrum range and reduce the cross talk of lights of other spectrum ranges, a light-absorbing member 700 can be disposed at the inner wall of the cladding member 600 and located between the spectroscopic structure 400 and the end of the optical fiber 508 adjacent to the spectroscopic structure 400, so as to absorb the lights of the undesired spectrum ranges.

It is worth mentioning that in some embodiments, all internal components of the housing 102 of the optically visualized anti-counterfeiting electronic integrated apparatus 100 (e.g., the housing 102, the spectroscopic structure 400, and the fiber optic assembly 500 shown in FIGS. 2, 3, and 4) can be manufactured by using the additive manufacturing technology. The additive manufacturing technology is known also as the 3D printing technology, and involves continually adding and stacking material to manufacture the desired object under the control of a computer. Therefore, the additive manufacturing technology can guarantee that the manufactured object is integrally formed without additional assembly procedures. In some embodiments, the configurations, the starting points, and the ending points of the fiber optic assemblies 500 can be designed by using a computer graphics algorithm, and the curvatures of the fiber optic assemblies 500 are minimized to ensure that the fiber optic assemblies 500 are separated from each other, so as to prevent lights of different spectrum ranges from cross talking. Furthermore, owing to the feature of integral formation associated with the additive manufacturing technology, the ends 502 and 504 of the fiber optic assembly 500 can be filled and trimmed flush respectively with the incident end 202 and the exit end 204.

Reference is made to FIG. 5. FIG. 5 is a front view of the display area 101 of an optically visualized anti-counterfeiting electronic integrated apparatus 100 according to an embodiment of the disclosure. As shown in FIG. 5, in some embodiments, a pattern 101a of a T-shaped mark can be displayed in the display area 101. To display a first color at a first region 101b within the T-shaped mark and display a second color at a second region 101c outside of the T-shaped mark, the designer can configure the ends 504 (i.e., the exit ends 204) of the fiber optic assemblies 500 by using a computer graphics algorithm to display the first color in the first region 101b and the second color in the second region 101c, so as to realize the T-shaped mark with different colors. Furthermore, in order to prevent the lights of different colors at the junction of the first region 101b and the second region 101c from cross talking, a light-absorbing material (not shown) can be disposed at the junction. Therefore, by making the exit ends 204 of all tunnels 200 in the first region 101b to output the second lights 304 of the first color and making the exit ends 204 of all tunnels 200 in the second region 101c to output the second lights 304 of the second color, the visualized pattern 101a can be displayed in the display area 101.

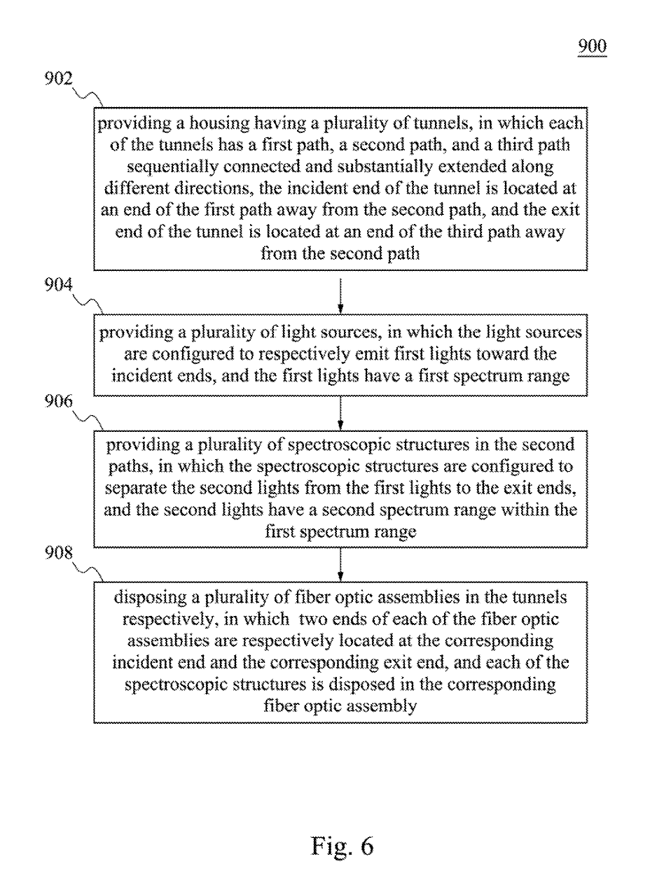

Reference is made to FIG. 6. FIG. 6 is a flow chart 900 of a manufacturing method of an optically visualized anti-counterfeiting electronic integrated apparatus 100 according to an embodiment of the disclosure. As shown in FIG. 6, in some embodiments, the manufacturing method of an optically visualized anti-counterfeiting electronic integrated apparatus 100 can be implemented by performing processes outlined in the flow chart 900. Each block in FIG. 6 represents one or more processes that can be performed in the flow chart 900. The order of the blocks is provided only as an example and can be changed as needed. Additional blocks can be provided or the blocks in FIG. 6 can be omitted without departing from the concept of the disclosure.

The flow chart 900 begins with block 902 in which a housing having a plurality of tunnels is provided. Each of the tunnels has a first path, a second path, and a third path sequentially connected and substantially extended along different directions. The incident end of the tunnel is located at an end of the first path away from the second path, and the exit end of the tunnel is located at an end of the third path away from the second path. With reference to FIG. 1 and FIG. 2, the optically visualized anti-counterfeiting electronic integrated apparatus 100 includes the housing 102. The housing 102 has the tunnel 200, and the tunnel 200 has a first path 206, a second path 208, and a third path 210 sequentially connected and substantially extended along different directions, in which the incident, end 202 is located at an end of the first path 206 away from the second path 210, and the exit end 204 is located at an end of the third path 210 away from the second path 208.

The flow chart 900 continues with block 904 in which a plurality of light sources are provided. The light sources are configured to respectively emit first lights toward the incident ends, and the first lights have a first spectrum range. With reference to FIG. 2, the optically visualized anti-counterfeiting electronic integrated apparatus 100 further includes the light sources 300. The light sources 300 are disposed in the optically visualized anti-counterfeiting electronic integrated apparatus 100 (FIG. 2 only shows a part of the housing 102), and are configured to respectively emit first lights 302 toward the incident ends 202, and the first lights 302 have a first spectrum range.

The flow chart 900 continues with block 906 in which a plurality of spectroscopic structures are respectively disposed in the second paths. The spectroscopic structures are configured to separate the second lights from the first lights to the exit ends, and the second lights have a second spectrum range within the first spectrum range. With reference to FIG. 2, the optically visualized anti-counterfeiting electronic integrated apparatus 100 further includes the spectroscopic structures 400. Each of the spectroscopic structures 400 has an incident surface 402 and an exit surface 404 respectively adjacent to the first path 206 and the third path 210. The incident surface 405 is configured to refract the first light 302 into the spectroscopic structure 400. The exit surface 404 is configured to refract the first light 302 in the spectroscopic structure 400 to obtain the second light 304 separated from the first light 302, and the second light 304 leaves the exit surface 404 and then enters the third path 210, in which the second light 304 has a second spectrum range within the first spectrum range.

The flow chart 900 continues with block 908 in which a plurality of fiber optic assemblies are respectively disposed in the tunnels. Two ends of each of the fiber optic assemblies are respectively located at the corresponding incident end and the corresponding exit end, and each of the spectroscopic structures is disposed in the corresponding fiber optic assembly. With reference to FIG. 3, in addition to the housing 102, the light sources 300, and the spectroscopic structures 400, the optically visualized anti-counterfeiting electronic integrated apparatus 100 further includes the fiber optic assemblies 500 disposed in the tunnels 200 of the housing 102. Two ends 502 and 504 of each of the fiber optic assemblies 500 are respectively located at the corresponding incident end 202 and the corresponding exit end 204. Each of the spectroscopic structures 400 is disposed in the corresponding fiber optic assembly 500.

In the blocks 902, 906, and 908, the housing 102, the spectroscopic structures 400, and the fiber optic assemblies 500 are manufactured by using the additive manufacturing technology. As discussed above, the additive manufacturing technology ensures that the manufactured object is integrally formed, so that the appearance of the housing 102 is substantially continuous, and users cannot visually and tactilely perceive differences, thereby enhancing the anti-counterfeiting properties.

According to the foregoing recitations of the embodiments of the disclosure, it can be seen that the internal structures in the optically visualized anti-counterfeiting electronic integrated apparatus of the disclosure can be modified by using the additive manufacturing technology to prevent vandalism or copying by reverse engineering. Moreover, the optically visualized anti-counterfeiting electronic integrated apparatus can be mass-produced. Furthermore, the optically visualized anti-counterfeiting electronic integrated apparatus of the disclosure complies with an optics-based design, which allows users to use their vision in a natural environment. Moreover, the optically visualized anti-counterfeiting electronic integrated apparatus of the disclosure can provide significantly more flexibility to designers by allowing a combination of light and color appearance, so as to allow easier identification.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An optically visualized anti-counterfeiting electronic integrated apparatus, comprising:
a housing having a plurality of tunnels, each of the tunnels having an incident end and an exit end respectively present on opposite sides of the housing;
a plurality of light sources configured to respectively emit first lights toward the incident ends, the first lights having a first spectrum range; and
a plurality of spectroscopic structures respectively disposed in the tunnels and respectively configured to separate second lights from the first lights to the exit ends, wherein the second lights have a second spectrum range within the first spectrum range.

2. The optically visualized anti-counterfeiting electronic integrated apparatus of claim 1, wherein each of the tunnels has a first path, a second path, and a third path sequentially connected and substantially extended along different directions, the incident end is located at an end of the first path away from the second path, the exit end is located at an end of the third path away from the second path, and each of the spectroscopic structures is located in the corresponding second path.

3. The optically visualized anti-counterfeiting electronic integrated apparatus of claim 2, wherein each of the spectroscopic structures has an incident surface and an exit surface respectively adjacent to the corresponding first path and the corresponding third path, the incident surface is configured to refract the first light into the spectroscopic structure, the exit surface is configured to refract the first light in the spectroscopic structure to obtain the second light separated from the first light, and the second light leaves the exit surface and then enters the corresponding third path.

4. The optically visualized anti-counterfeiting electronic integrated apparatus of claim 1, further comprising a plurality of fiber optic assemblies respectively disposed in the tunnels, wherein two ends of each of the fiber optic assemblies are respectively located at the corresponding incident end and the corresponding exit end, and each of the spectroscopic structures is disposed in the corresponding fiber optic assembly.

5. The optically visualized anti-counterfeiting electronic integrated apparatus of claim 4, wherein each of the fiber optic assemblies comprises:
two optical fibers respectively located between the corresponding incident end and the corresponding spectroscopic structure and between the corresponding spectroscopic structure and the corresponding exit end; and
a cladding member enveloping the optical fibers and the corresponding spectroscopic structure.

6. The optically visualized anti-counterfeiting electronic integrated apparatus of claim 5, wherein each of the fiber optic assemblies further comprises:
a light-absorbing member disposed at the inner wall of the cladding member and located between the corresponding spectroscopic structure and the optical fiber adjacent to the exit surface.

7. The optically visualized anti-counterfeiting electronic integrated apparatus of claim 4, wherein the ends of each of the fiber optic assemblies are respectively filled and trimmed flush with the corresponding incident end and the corresponding exit end.

8. The optically visualized anti-counterfeiting electronic integrated apparatus of claim 1, wherein each of the spectroscopic structures is at least a part of a prism, and the part is configured to refract the first light twice.

9. A manufacturing method of an optically visualized anti-counterfeiting electronic integrated apparatus, comprising:
providing a housing having a plurality of tunnels, wherein each of the tunnels has an incident end and an exit end respectively present on opposite sides of the housing;
providing a plurality of light sources, wherein the light sources are configured to respectively emit first lights toward the incident ends, and the first lights have a first spectrum range; and
disposing a plurality of spectroscopic structures in the tunnels respectively, wherein each of the spectroscopic structures is configured to separate a second light from the first light to the corresponding exit end, and the second light has a second spectrum range within the first spectrum range.

10. The manufacturing method of claim 9, wherein the providing of the housing comprises:
forming a first path, a second path, and a third path sequentially connected and substantially extended along different directions in the housing to form each of the tunnels, wherein each of the incident ends, is located at an end of the corresponding first path away from the corresponding second path, each of the exit ends is located at an end of the corresponding third path away from the corresponding second path, and each of the spectroscopic structures is located in the corresponding second path.

11. The manufacturing method of claim g, wherein the disposing of the spectroscopic structures comprises:
disposing a plurality of fiber optic assemblies in the tunnels respectively, wherein two ends of each of the fiber optic assemblies are respectively located at the corresponding incident end and the corresponding exit end, and each of the spectroscopic structures is disposed in the corresponding fiber optic assembly.

12. The manufacturing method of claim 11, wherein the providing of the housing and the disposing of the fiber optic assemblies e performed by using the additive manufacturing technology.
